(19) United States
(12) Patent Application Publication
(10) Pub. No.: US 2005/0127872 A1
(43) Pub. Date: Jun. 16, 2005

(54) Gang battery charger and conditioner

(76) Inventor: Gabor Lederer, Paterson, NJ (US)

Correspondence Address: ISRAEL NISSENBAUM, 1038-56TH ST, BROOKLYN, NY, 11219, US

(21) Appl. No.: 10/987,937

(22) Filed: Nov. 12, 2004

Related U.S. Application Data
(60) Provisional application No. 60/519,173, filed on Nov. 12, 2003.

(51) Int. Cl. H02J 7/00

(52) U.S. Cl. 320/116

(57) ABSTRACT

A battery charger in a ganged arrangement for the recharging of batteries in electrically simulated candles with circuitry arranged for proper battery conditioning. Overcharging is negated.

### FIELD OF THE INVENTION

This application claims the benefit of priority under 35 USC 119(e) of provisional application Ser. No. 60/519,173, filed Nov. 12, 2003. The entire disclosure of said provisional application being incorporated herein by reference thereto.

This invention relates to chargers for rechargeable batteries and particularly for NiCad and NiMH batteries (which are very popular for consumer electronic use) and multiple battery chargers.

### BACKGROUND OF THE INVENTION

With the prevalence of portable electronic devices with low power requirements, batteries have become the norm. Primary batteries, with relatively high energy density and power capacity are suitable only for single use and are therefore not desirable for both economical and logistical reasons especially in constantly utilized applications such as phones, computers and the like. Rechargeable batteries, such as those having nickel/cadmium (NiCad) and nickel/metal hydride (NIMH) electrodes are commonly used particularly with cordless and cellular phones. Lithium polymer or ion batteries have been developed with greater capacity and higher voltage capability but are more expensive and have restrictions on the number of recharge cycles.

A common feature of all rechargeable batteries is the need for chargers. Such chargers have usually been embodied in single battery holding cradles with conditioners used to maintain them and are able to handle and charge only one battery-set at a time.

There are other applications, aside from single battery containing phones, which require the use of multiple devices and thus multiple battery charging capability. However the chargers commonly used operate in a time inefficient manner of serial charging. A burgeoning application is that of electronic simulating candles. This application often requires that several candles be used at the same time and accordingly such candles require special gang chargers (4, 6, 12, or as many as 24 candles or more at a time) for battery utilization efficiency.

Presently there is no charger on the market which follows the manufacturer requested battery charging/reconditioning characteristics for multiple batteries used in rechargeable electronic candles. Currently available chargers additionally shorten the lifetime of the batteries because they tend to overcharge the batteries without monitoring of the internal resistance. With such chargers, the level of charge is not controlled and none of them have a reconditioning where the battery is discharged completely to avoid hysteresis.

### SUMMARY OF THE INVENTION

It is accordingly an object of the present invention to provide a gang type of charger/discharger device, to alleviate the problem of overcharging and to eliminate hysteresis when the batteries are not completely discharged during their use.

This and other objects, features and advantages of the present invention will be more evident from the following discussion and the drawings in which:

### SHORT DESCRIPTION OF THE DRAWINGS

FIG. 1 is a circuit suitable for the gang battery charger of the present invention;

FIG. 2 is a perspective view of the gang battery charger of the present invention fully populated with candles for charging;

FIG. 3 is a perspective view of one charging row of the charger of FIG. 2 with candles removed for clarity;

FIGS. 4a and 4b are side and top view of a metal multiplying bar allowing any number of charging rows of FIG. 3 to be connected; and

FIGS. 5a and 5b are top and bottom views of the base of the charger of FIG. 2 with placement of two rows of FIGS. 3 and bars of FIGS. 4a and 4b.

Generally the present invention comprises a multiple-battery charger, particularly one configured to accommodate a device such as an electronic candle each having a battery contained therein. The device comprises a non-power actuated self-discharging circuitry wherein the discharge circuitry comprises means for setting a predetermined discharge rate and wherein said circuit further comprises a timer controlled disconnecting switch element.

The battery charging device of further preferably comprises a single current generator having said timer controlled switch, and means for charging multiple of batteries arranged in groups of either or both serial and parallel connection and wherein a zener diode distributes and bridges the individual groups.

In a further preferred embodiment the battery charging device is comprised of group charger configurations which are housed in modular elements wherein multiple charger elements can be assembled from the same components.

In the preferred embodiment, the battery charging device is configured for charging of batteries contained in asymmetrically configured electronic candles during said charging and said device comprises means for holding the candles, with contained batteries, in a proper charging position.

### DETAILED DESCRIPTION OF THE INVENTION

The charger of the present utilizes a constant current generator set for 1/10 C, wherein “C” is the battery capacity. For simplicity and economics the batteries are preferably charged in a series arrangement whereby only one current generator is utilized. Parallel as well as mixed parallel and series arrangement are similarly possible with alternate circuitries and appropriate structural modifications.

In the charger, every battery is provided with a selected zener diode in a parallel configuration in order to clamp the voltage to a predetermined value and to provide continuity if the battery is defective (open). Each battery is provided with an individual discharge circuitry which starts to work when the battery is placed in position for charging. The discharger circuitry operates without external power and the discharging circuitry is designed such that when the battery reaches the factory recommended discharge level, discharging stops automatically and the battery will not be damaged from over discharging.

After a pre-calculated time (based on the calculated discharge time of an average battery (or battery set)) a timer is programmed to stop all discharge circuitries and the charger mode is activated. By this time an average battery should be discharged completely and ready to be charged. This assures that the batteries are charged/discharged optimally with no degradation in the useful lifetime of the battery(ies).

### DETAILED DESCRIPTION OF THE DRAWINGS AND THE PREFERRED EMBODIMENT

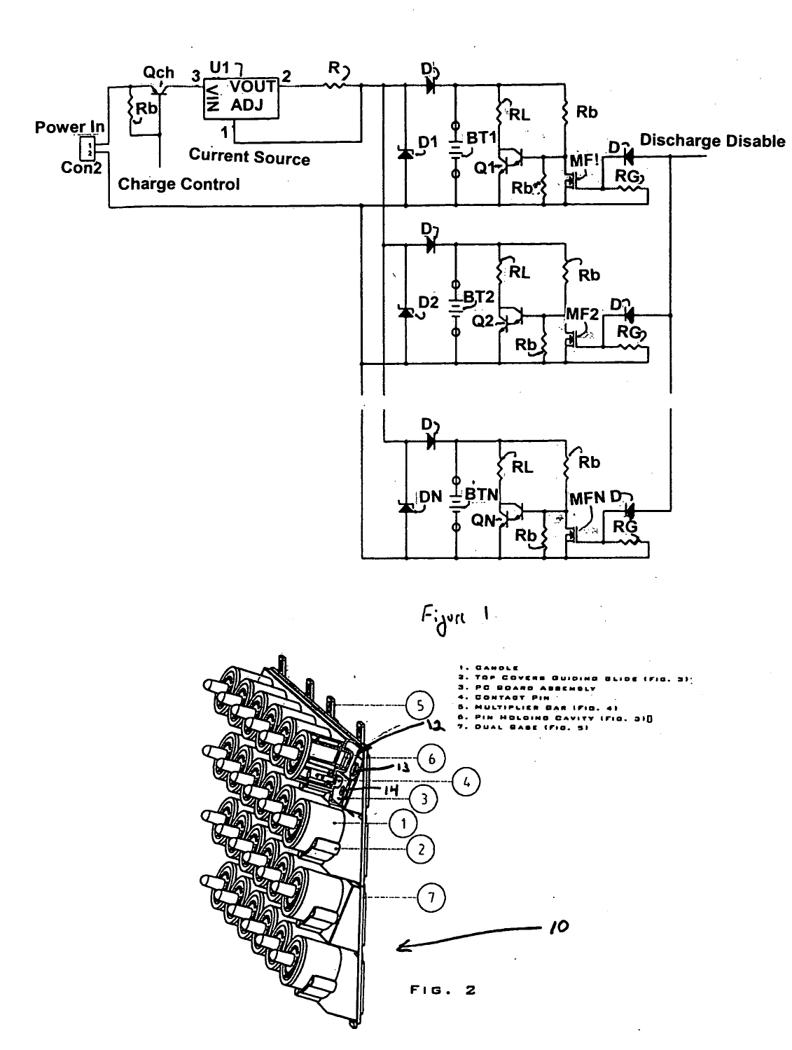

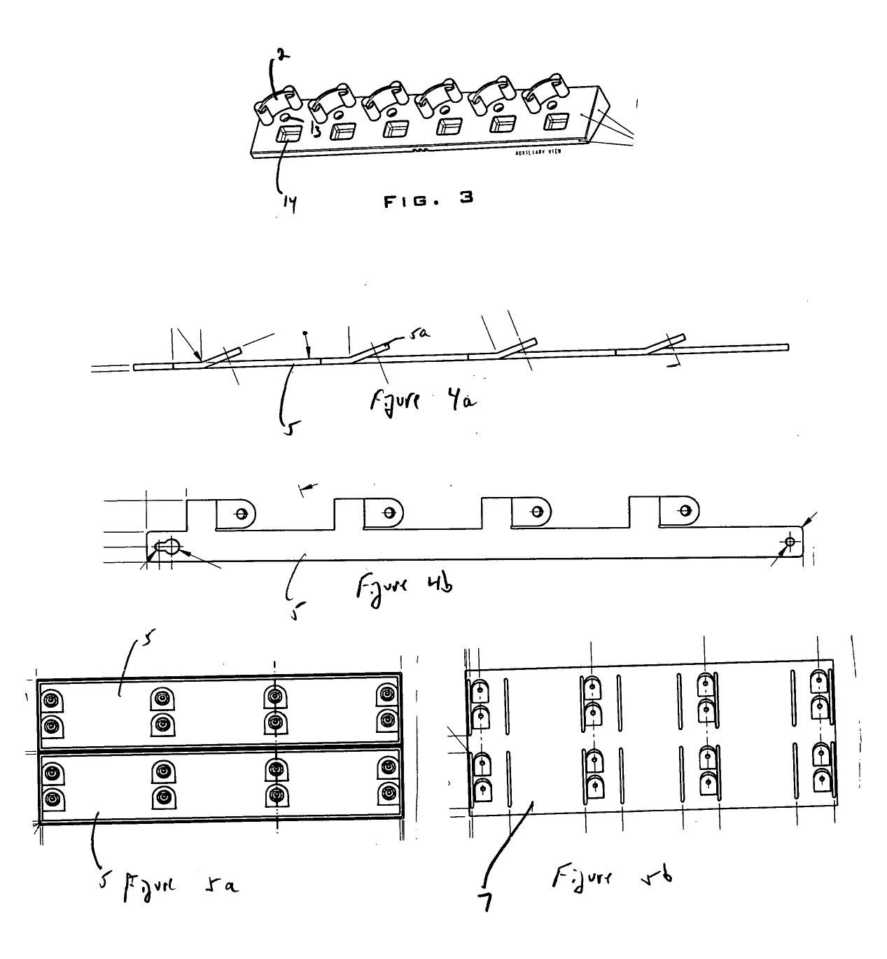

With reference to the drawings, FIG. 1 depicts an embodiment of the circuitry utilizable in the present inventions. The circuit, as shown, manages the proper battery charge/discharge cycle for the charger 10 shown in FIG. 2. Both the electronics of the circuit and the housing therefor are of modular designs and as shown in FIGS. 3-4 as modules of charging positions or rows or nests which can be expanded in modules of groups of, for example, as shown, six charging positions. FIG. 2 is a preferred charger with 4 modules of six charging positions, with a total of 24 charging positions.

In the circuit in FIG. 1, in operation, the U1 current source passing through R resistor provides a constant 1/10 C current, with C being the individual battery nominal capacity. Though the circuit schematic shows a charger nest 1, 2 . . . n, it can readily be configured for any number of charging modules or positions which may be in serial/parallel, depending on the current generator capacity and its voltage.

The elements D1, D2 . . . DN are clamping zener diodes which determine the maximum voltage that the charging row or nest will have. These zener diodes also provide a path for the power if an associated battery is defective or open. The diodes D serve to prevent reverse current flow from one nest to the other. Discharge switching transistors Q1, Q2 . . . QN are driven by the battery residual voltage and, with the discharge current limiter resistors RL and and resistors Rb insure that the batteries do not over discharge.

Initially, the QCh transistor turns off the constant current source. When a preset time period elapses, timer circuitry (not shown), in conjunction with the discharge-disable transistors MF1, MF2 . . . MFN, circuitry turns off the discharge transistors Q1, Q2 . . . QN circuitries and turns on the current source and the charge will begin.

The charger 10, as shown in FIG. 2, is shown as an open cross-section being populated with twenty four candles 1 for charging, with the candle at position 12 being shown in cross-section for clarity. PC board assembly 3 with the circuit of FIG. 1, is shown at position 12, as is pin engaging cavity 14. Metal bars 5, with extending elements 5a electrically connect and provide circuit charging for the four candle rows. Guiding slides 2, more clearly seen in FIG. 3, are configured to guide co-fitting battery powered candles 1 into place and fix them into position (asymmetry of the charging connection ensures proper placement) for charging. The battery terminals and charging pins of the candles 1 (not shown) are located at the base of the candles and, as shown in FIG. 3, are fitted for electrical charging engagement in apertures 13 and 14.

As shown in FIGS. 4a and 4b and FIGS. 5a and 5b, metal conductive bars 5 are placed in cavities shown in FIGS. 5a and 5b, beneath base element 7 for modularly connecting additional charging rows or nests. As shown, the base element 7 in FIGS. 5a and 5b is configured for accommodation of two conductive bars 5. The charging circuit of FIG. 1 is adapted to modularly accommodate the additional rows or nests of charging positions.

It is understood that the above description and drawings are exemplary of the present invention and that changes in structure, configuration and candle type may be made without departing from the scope of the present invention as defined in the following claims.

1. A multiple battery charging device comprising a non-power actuated self-discharging circuitry wherein the discharge circuitry comprises means for setting a predetermined discharge rate and wherein said circuit further comprises a timer controlled disconnecting switch element.

2. The battery charging device of claim 1 comprising a single current generator having said timer controlled switch, wherein said device comprises means for charging multiple of batteries arranged in groups of either or both serial and parallel connection and wherein a zener diode distributes and bridges the individual groups.

3. The battery charging device of claim 2 wherein said groups arrangements are housed in modular elements wherein multiple charger elements can be assembled from the same components.

4. The battery charging device of claim 1, wherein the batteries are contained in asymmetrically configured electronic candles during said charging and said device comprises means for holding said candles with contained batteries in a proper charging position.
